(19) United States
(12) Patent Application Publication
(10) Pub. No.: US 2025/0183486 A1
(43) Pub. Date: Jun. 5, 2025

(54) ELECTRODE LAMINATE AND BATTERY

(71) Applicant: TOYOTA JIDOSHA KABUSHIKI KAISHA, Toyota-shi (JP)

(72) Inventors: Hiroshi NAGASE, Nagoya-shi (JP); Kenichi KAKISHITA, Nagoya-shi (JP); Shinya ISHIKAWA, Toyota-shi (JP); Ryo KAGAMI, Ichinomiya-shi (JP); Norihiro OSE, Nagoya-shi (JP)

(73) Assignee: TOYOTA JIDOSHA KABUSHIKI KAISHA, Toyota-shi (JP)

(21) Appl. No.: 18/782,205

(22) Filed: Jul. 24, 2024

(30) Foreign Application Priority Data
Dec. 1, 2023 (JP) 2023-204047

(51) Int. Cl. H01M 50/486; H01M 50/474; H01M 50/477

(52) U.S. Cl. CPC H01M 50/486; H01M 50/474; H01M 50/477

(57) ABSTRACT

In the electrode laminate of the present disclosure, a fixing member including a curable resin is disposed on at least one side surface portion. In the electrode laminate of the present disclosure, the fixing member is composed of two or more partial fixing members spaced apart from each other. Further, the battery of the present disclosure includes the electrode laminate of the present disclosure and a laminate film sealing the electrode laminate.

### CROSS-REFERENCE TO RELATED APPLICATION

This application claims priority to Japanese Patent Application No. 2023-204047 filed on Dec. 1, 2023, incorporated herein by reference in its entirety.

### BACKGROUND

### 1. Technical Field

The present disclosure relates to an electrode laminate and a battery.

### 2. Description of Related Art

In a secondary battery such as a lithium-ion battery or the like, an electrode laminate may be used. With regard to such an electrode laminate, a technology has been developed in which a fixing member including a curable resin is provided on a side face portion of the electrode laminate, in order to suppress misalignment or the like of the layers.

For example, Japanese Unexamined Patent Application Publication No. 2021-114374 (JP 2021-114374 A) discloses a method for manufacturing an all-solid-state battery. The all-solid-state battery according to JP 2021-114374 A includes a flat-shaped laminated electrode body (electrode laminate), an encasement made of a laminated film that accommodates the laminated electrode body, and a resin protective member (fixing member) formed on a side face of the laminated electrode body.

JP 2021-114374 A also discloses use of a resin material having photocuring properties or thermosetting properties, as the protective member.

### SUMMARY

The fixing member including the curable resin may peel away from the electrode laminate, and as a result, there is a problem that functions for serving as the fixing member cannot be sufficiently exhibited.

An object of the present disclosure is to provide an electrode laminate in which a fixing member disposed on a side face portion thereof does not readily peel off, and a battery having such an electrode laminate.

The present disclosers found that the above problem can be solved by the following means.

### First Aspect

An electrode laminate in which a fixing member including a curable resin is disposed on at least one side face portion, in which
the fixing member is made of two or more partial fixing members that are disposed spaced apart from one another.

### Second Aspect

In the electrode laminate according to the First Aspect, the following relational expression

thickness of the fixing member≤(1/width of the partial fixing member)×100 is satisfied.

### Third Aspect

In the electrode laminate according to the First or Second Aspect, the thickness of the fixing member is no less than 50 μm and no more than 5 mm.

### Fourth Aspect

A battery includes
the electrode laminate according to any one of the First to Third Aspects, and
a laminate film sealing the electrode laminate.

According to the present disclosure, an electrode laminate in which a fixing member disposed on a side face portion thereof does not readily peel away, and a battery having such an electrode laminate, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of an electrode laminate of the present disclosure;

FIG. 2A is a schematic side view of an electrode laminate according to the present disclosure;

FIG. 2B is a schematic side view of an electrode laminate according to the present disclosure;

FIG. 3 is a schematic plan view of the disclosed cell; and

FIG. 4 is a schematic diagram of an electrode laminate according to the prior art.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Electrode Laminate

In the electrode laminate of the present disclosure, a fixing member including a curable resin is disposed on at least one side surface portion. In the electrode laminate of the present disclosure, the fixing member is composed of two or more partial fixing members spaced apart from each other.

The Discloser and others thought that one of the causes of the fixing member including the curable resin being peeled off from the electrode laminate was due to the stress generated with the hardening shrinkage of the curable resin.

In this regard, the inventors of the present disclosure have found that by forming the fixing member from two or more partial fixing members spaced apart from each other, it is possible to prevent the fixing member containing the curable resin from being peeled off from the electrode laminate. The reason for this is not intended to be bound by any theory, but it is considered that by providing a portion where the fixing member is not disposed on the side surface portion of the electrode laminate, it is possible to relax the stress generated due to the curing shrinkage of the curable resin.

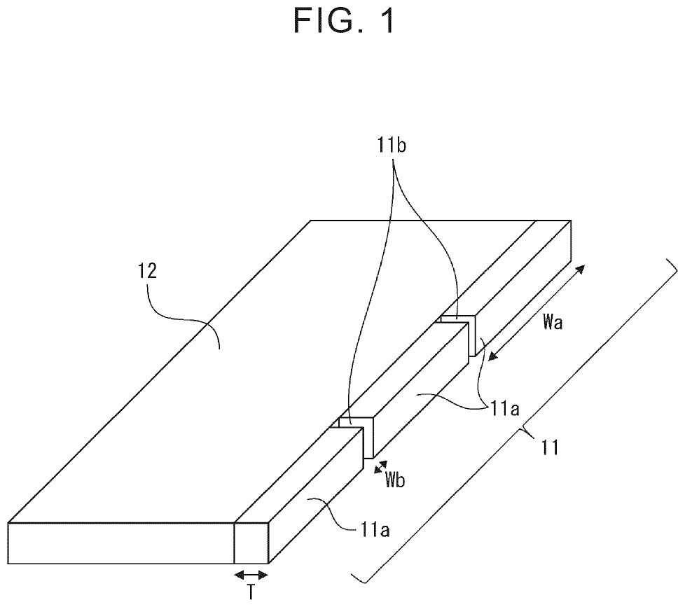

Hereinafter, the electrode laminate 12 of the present disclosure will be described with reference to FIG. 1. In FIG. 1 and other drawings, dimensional relationships (length, width, thickness, and the like) do not reflect actual dimensional relationships. FIG. 1 is a schematic diagram of an electrode laminate 12 of the present disclosure. The shape of the electrode laminate 12 is not particularly limited, but may include, for example, as shown in FIG. 1, a top surface portion, a bottom surface portion opposed to the top surface portion, and four side surface portions connecting the top surface portion and the bottom surface portion. Further, in the electrode laminate 12 of the present disclosure, the fixing member 11 including the curable resin is disposed on at least one side surface portion.

In the present disclosure, the term “electrode laminate” means a stack constituting one or a plurality of unit cells. Here, the “unit cell” may include a laminate of a positive electrode current collector layer, a positive electrode active material layer, an electrolyte layer (separator layer), a negative electrode active material layer, and a negative electrode current collector layer.

The fixing member 11 may be disposed on two or more side surfaces of the electrode laminate 12. In particular, a fixing member may be disposed on a pair of opposing side surface portions of the electrode laminate 12, and another member such as a current collector terminal may be disposed on the remaining pair of side surface portions. In this case, the effect of suppressing the displacement of the electrode by the fixing member 11 is improved, and it is easy to prevent the short circuit caused by the mixing of the conductive foreign matter and the damage caused by the external impact.

Examples of the curable resin include, but are not limited to, photocurable resins such as ultraviolet curable resins and electron beam curable resins, and thermosetting resins. The curable resin may be a radically polymerizable resin, a cationically polymerizable resin, or a combination thereof.

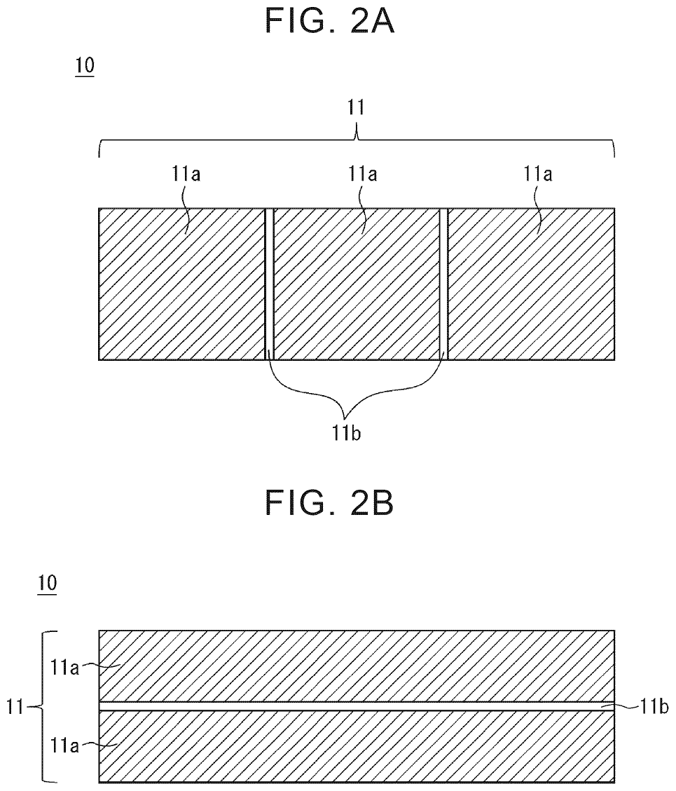

FIGS. 2A and 2B are schematic side views of the electrode laminate 12 according to the present disclosure. As shown in FIG. 1 and FIGS. 2A and 2B, the fixing member 11 is comprised of two or more partial fixing member 11a arranged at spaced 11b from each other. The number of partial fixing members may be 3 or more, 4 or more, or 5 or more, and may be 10 or less, 8 or less, 6 or less, 5 or less, or 4 or less.

As a method of disposing the fixing member 11 in this manner, for example, a method of applying a curable resin to the side surface portion of the electrode laminate with a space therebetween is exemplified. Alternatively, as a method of disposing the fixing member 11 in this manner, for example, a method of applying the curable resin to the side surface portion of the electrode laminate without spacing, and then removing the resin adhering to the portion to be spaced apart is exemplified.

A width Wa of the partial fixing member 11a may be 10 mm or more, 50 mm or more, 80 mm or more, 90 mm or more, or 100 mm or more. Further, the width Wa of the partial fixing member 11a may be less than or equal to 200 mm, less than or equal to 150 mm, less than or equal to 130 mm, less than or equal to 120 mm, less than or equal to 110 mm, or less than or equal to 100 mm.

The width Wb of the spacing 11b may be 0.1 mm or more, 0.5 mm or more, 1 mm or more, 2 mm or more, or 3 mm or more, and may be less than or equal to 10 mm, less than or equal to 7 mm, less than or equal to 5 mm, less than or equal to 4 mm, or less than or equal to 3 mm.

The thickness T of the fixing member 11 may be 50 μm or more and 5 mm or less. The thickness T may be 100 μm or more, 500 μm or more, 750 μm or more, or 1 mm or more, and may be not less than 4 mm, not more than 3 mm, not more than 2 mm, or not more than 1 mm. When the thickness T is large, it is easy to prevent the electrode from being displaced and short-circuited due to the inclusion of conductive foreign matters. When the thickness T is small, the loss of the energy density of the battery can be reduced, and the stress generated due to the curing shrinkage of the curable resin is easily suppressed. The thickness T may be an average thickness of the entire fixing member 11.

The thickness T of the fixing member 11 and the width Wa of the partial fixing member 11a may satisfy the following relation:

Thickness T of the fixing member 11≤(1/width Wa of partial fixing member)×100.

That is, the larger the width Wa of the partial fixing member, the smaller the thickness T of the fixing member 11 may be.

As a method of preparing the thickness T of the fixing member 11, for example, a method of preparing the viscosity at the time of applying the curable resin for forming the fixing member 11 is exemplified.

The length of the fixing member 11 in the stacking direction of the electrode laminate 12 may be smaller than the thickness of the electrode laminate 12. With such a configuration, it is possible to suppress an increase in the thickness of the battery 10 of the present disclosure, and therefore, it is possible to restrain the battery 10 so that the fixing member 11 does not interfere with the pressure equalization of the battery 10 when the battery module is formed.

### Battery

Hereinafter, the battery 10 of the present disclosure will be described with reference to FIG. 3. FIG. 3 is a schematic plan view illustrating an example of the battery 10 of the present disclosure when viewed in plan from the stacking direction of the electrode laminate 12.

As shown in FIG. 3, a battery 10 of the present disclosure includes an electrode laminate 12 of the present disclosure and a laminate film 13 that seals the electrode laminate 12.

### Electrode Laminate

The electrode laminate 12 functions as a power generation element of a battery. For the electrode laminate 12, reference can be made to the above description of the electrode laminate of the present disclosure.

### Laminate Film

The laminate film 13 optionally wraps the electrode laminate 12 to seal the electrode laminate 12. The laminate film 13 may include a welded layer and a metal layer, and the electrode laminate 12 may be sealed by, for example, welding the welded layers and/or the welded layer and a current collector terminal 15 to be described later. The material of the welding layer may be, for example, a resin that can be welded by heat.

As shown in FIG. 3, the battery 10 of the present disclosure may further include a current collector terminal 15 electrically connected to the current collector foil 14 of the electrode laminate 12. Further, in the battery 10 of the present disclosure, as shown in FIG. 3, the laminate film 13 may wrap the electrode laminate 12 and the current collector terminal 15 to seal the electrode laminate 12 together with the current collector terminal 15.

### Current Collector Foil

The current collector foil 14 may extend from a side surface portion of the side surface portion of the electrode laminate 12 where the fixing member 11 is not disposed. The current collector foil 14 may be a bundle of portions of the positive electrode current collector of the electrode laminate 12 where other layers are not laminated, and a bundle of portions of the negative electrode current collector of the electrode laminate 12 where other layers are not laminated.

### Current Collector Terminal

The current collector terminal 15 may be electrically connected to the current collector foil 14. The material of the current collector terminal 15 is not particularly limited as long as it is a material having a current collector function, and can be, for example, the same metal material as that of the positive electrode current collector and the negative electrode current collector.

A method of bonding the current collector terminal and the current collector foil is not particularly limited, but an example of a method of bonding by ultrasonic waves is exemplified.

A method of welding the laminate film to the current collector terminal is not particularly limited, but a method of heat welding is exemplified.

The battery of the present disclosure may be a liquid-based battery or a solid-state battery. In the context of the present disclosure, a “solid battery” means a battery using at least a solid electrolyte as an electrolyte, and therefore a solid battery may use a combination of a solid electrolyte and a liquid electrolyte as an electrolyte. The solid-state battery of the present disclosure may be an all-solid-state battery, that is, a battery using only a solid electrolyte as an electrolyte.

The battery of the present disclosure may be a lithium-ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving of hybrid electric vehicle (HEV), plug-in hybrid electric vehicle (PHEV), or battery electric vehicle (BEV). Also, the battery in the present disclosure may be used as a power source for mobile bodies other than vehicles (for example, railroads, ships, and aircraft), and may be used as a power source for electric products such as an information processing device.

### Preparation of Electrode Laminate

### Example 1

A fixing member was disposed on a pair of opposing side surface portions of the electrode laminate as shown in FIG. 2A in the following manner. That is, an ultraviolet curable resin (Aronix, Toagosei Co., Ltd.) was applied to a pair of opposite side surfaces of the electrode laminate at intervals, and the resin was cured by irradiation with ultraviolet rays, thereby disposing a partial fixing member. The width of the partial fixing member was 100 mm, the width of the spacing was 3 mm, and the thickness of the fixing member was 1 mm. The thickness of the fixing member and the width of the partial fixing member satisfy the following relational expression:

Thickness of the fixing member≤(1/width of the partial fixing member)×100.

### Comparative Example 1

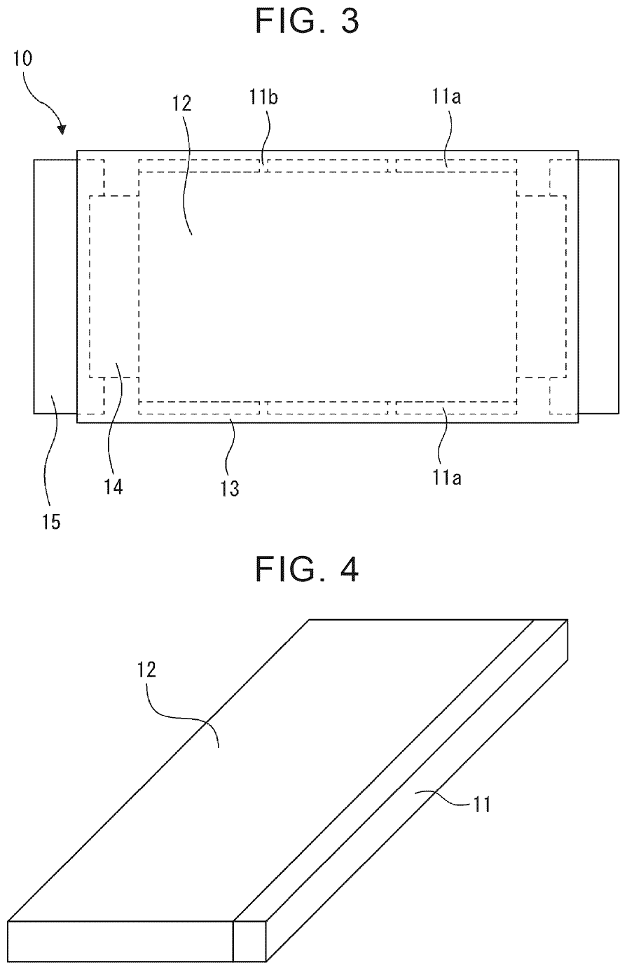

As shown in FIG. 4, a fixing member was arranged on the side surface portion of the electrode laminate in the same manner as in Example 1 except that the ultraviolet curable resin was applied without the above-described spacing such that the width of the fixing member is 250 mm and the thickness of the fixing member is 2.5 mm.

### Evaluation

When 10 electrode laminates of Example 1 and Comparative Example 1 were prepared, the defective product (peeling of the fixing member occurred) ratio was evaluated.

### Results

In the electrode laminate of Example 1 in which the fixing members were composed of two or more partial fixing members spaced apart from each other, the defective product rate was 0%. On the other hand, in the electrode laminate of Comparative Example 1 in which one fixing member was disposed, the defective product ratio was 40%.

What is claimed is:

1. An electrode laminate in which a fixing member including a curable resin is disposed on at least one side face portion, wherein the fixing member is made of two or more partial fixing members that are disposed spaced apart from one another.

2. The electrode laminate according to claim 1, wherein the following relational expression
thickness of the fixing member≤(1/width of the partial fixing member)×100 is satisfied.

3. The electrode laminate according to claim 1, wherein the thickness of the fixing member is no less than 50 μm and no more than 5 mm.

4. A battery comprising:
the electrode laminate according to claim 1; and
a laminate film sealing the electrode laminate.
